(19) United States
(12) Patent Application Publication
(10) Pub. No.: US 2008/0196569 A1
(43) Pub. Date: Aug. 21, 2008

(54) Blade vertically elevating device for a table saw

(76) Inventor: Bor-Yann Chuang, Taiping City (TW)

Correspondence Address: BRUCE H. TROXELL, SUITE 1404, 5205 LEESBURG PIKE, FALLS CHURCH, VA, 22041, US

(21) Appl. No.: 11/708,710

(22) Filed: Feb. 21, 2007

(51) Int. Cl. B23D 47/04

(52) U.S. Cl. 83/477.1

(57) ABSTRACT

A blade vertically elevating device for a table saw is positioned in a saw base installed in a base pf a table saw. The saw base includes a rotating base, the blade vertically elevating device and a motor. The blade elevating device consists of an elevating base, a main driving member, a threaded guiding rod and two guiding rods. The elevating base is engaged with the guiding rods, having a round blade set and a separating plate set behind the top of the round blade set. The threaded guiding rod is connected with a bevel gear engaged with a bevel gear of the main driving member. The elevating base, the motor, the round blade set and the separating plate can be spontaneously moved vertically together when the threaded guiding rod is driven by the main driving member to move spirally.

### BACKGROUND OF THE INVENTION

1. Field of the invention

This invention relates to a table saw, particularly to one having a blade vertically elevating device able to spontaneously keep an elevating base, a motor, a round blade member and a separating plate moved vertically together in a shortest distance.

2. Description of the Prior Art

As shown in FIGS. 1 and 2, a conventional table saw 10 mainly includes a saw base 12 fixed pivotally on a table 111 of a base 11. The saw base 12 is provided with a round blade 121 extended above the table 111 to carry out sawing, a fan-type gear 122 installed at one side of the round blade 121 and a worm shaft 123 pivotally fixed the base 11 to control the fan-shaped gear 122. By means of the worm shaft 123, the fan-shaped gear 122 can be controlled to alter its position so as to correspondingly adjust the thickness the round blade 121 is to cut. In addition, a separating plate 124 is fixed behind the top of the round blade 121, extended above the table 111 to be connected with a blade guard 125 for covering above the round blade 121 to prevent a user from hurt by the round blade while sawing. But, when the round blade 121 is driven by the worm shaft 123 to alter its level, the space between the blade guard connector 124 of the saw base 12 and the round blade 121 is correspondingly changed. In other words, if the round blade 121 is descended to reduce its sawing thickness, the space between the blade guard connector 124 and the round blade 121 is to be increased to keep the blade guard 125 unable to have an effective protection, apt to keep a user's fingers trapped in the space to be hurt by the round blade 121. Moreover, the round blade 121 is eccentrically oscillated to ascend or descend for changing its level while adjusting the worm shaft 123, taking too long a track to waste time.

### SUMMARY OF THE INVENTION

The objective of this invention is to offer a blade vertically elevating device.

The table saw includes a base installed with a saw base inside it. The saw base is composed of a rotating base, the blade elevating device and a motor. The blade elevating device consists of an elevating base, a main driving member, a threaded guiding rod and two guiding rods. The elevating base is engaged with the guiding rods, provided with a round blade set and a separating plate set behind the top of the round blade set. The threaded guiding rod is connected with a bevel gear engaged with a bevel gear of the main driving member. The elevating base, the motor, the round blade set and the separating plate can be spontaneously moved vertically together when the threaded guiding rod is driven by the main driving member to move spirally. Therefore, the space between the round blade and the separating plate is maintained unchanged to promise a user a safety machine. And, the round blade set is moved spontaneously together with the elevating base in a vertical track, able to alter its level as quickly as possible.

### BRIEF DESCRIPTION OF DRAWINGS

This invention is better understood by referring to the accompanying drawings, wherein:

FIG. 1 is a perspective view of a conventional table saw;

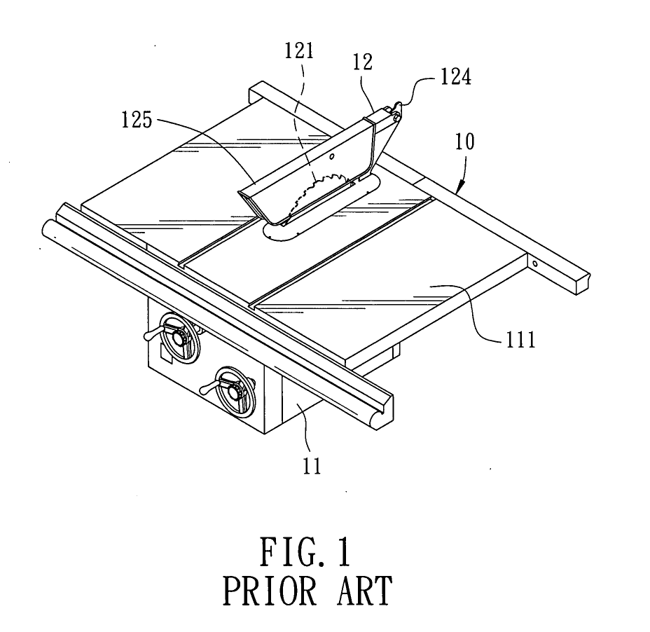

FIG. 2 is a perspective view of a saw base of the conventional table saw;

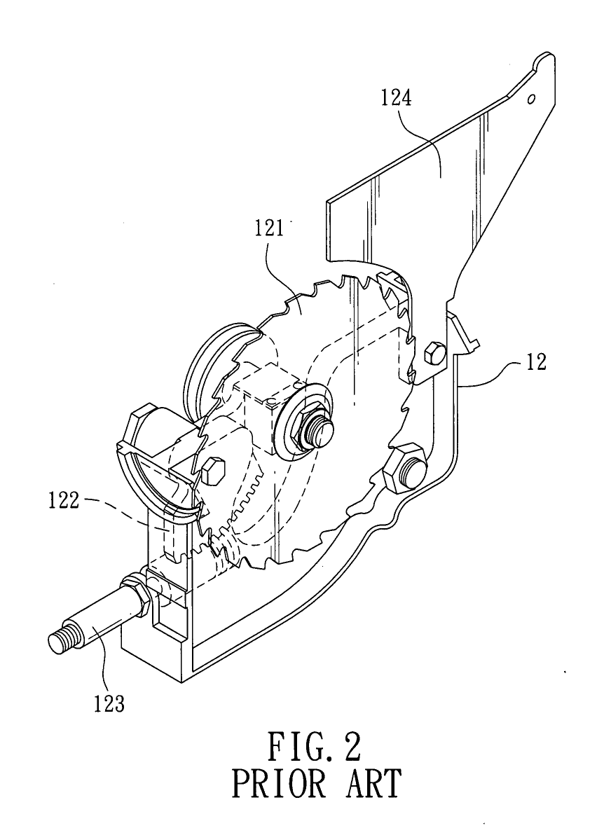

FIG. 3 is a perspective view of a preferred embodiment of a table saw with a blade vertically elevating device in the present invention;

FIG. 4 is a partial perspective view of a saw base of the preferred embodiment of a table saw with the blade vertically elevating device in the present invention;

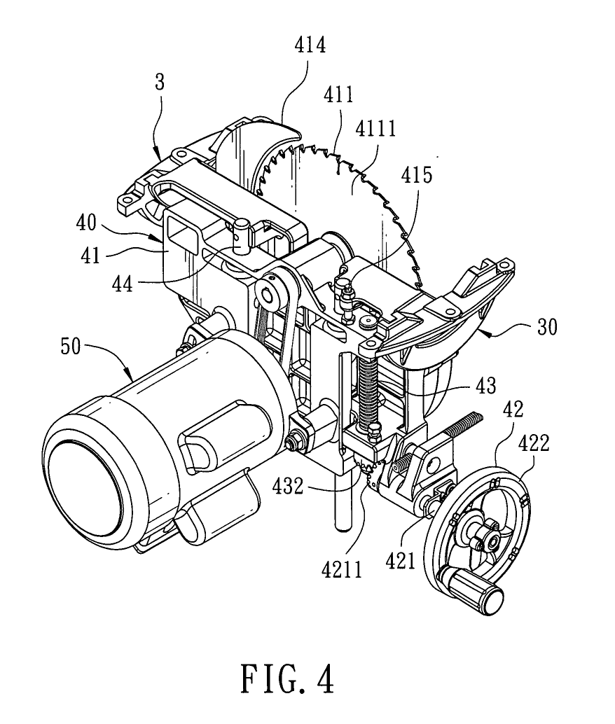

FIG. 5 is an exploded perspective view of the saw base of the preferred embodiment of a table saw with the blade vertically elevating device in the present invention;

FIG. 6 is a side view of the saw base of the preferred embodiment of a table saw with a blade vertically elevating device in the present invention;

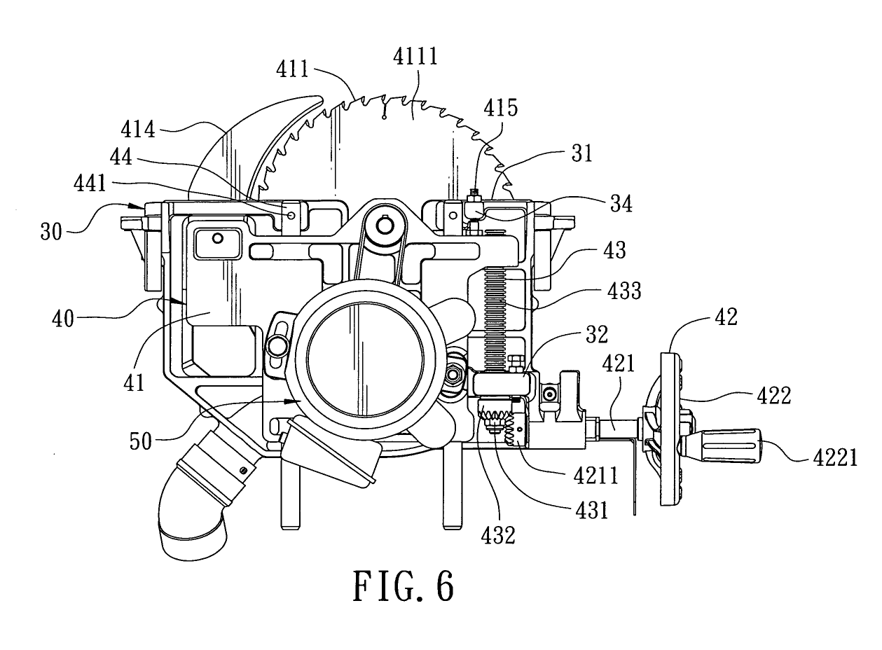

FIG. 7 is a side view of the saw base of the preferred embodiment of a table saw with the blade vertically elevating device in the present invention, showing the blade being adjusted to change its level; and

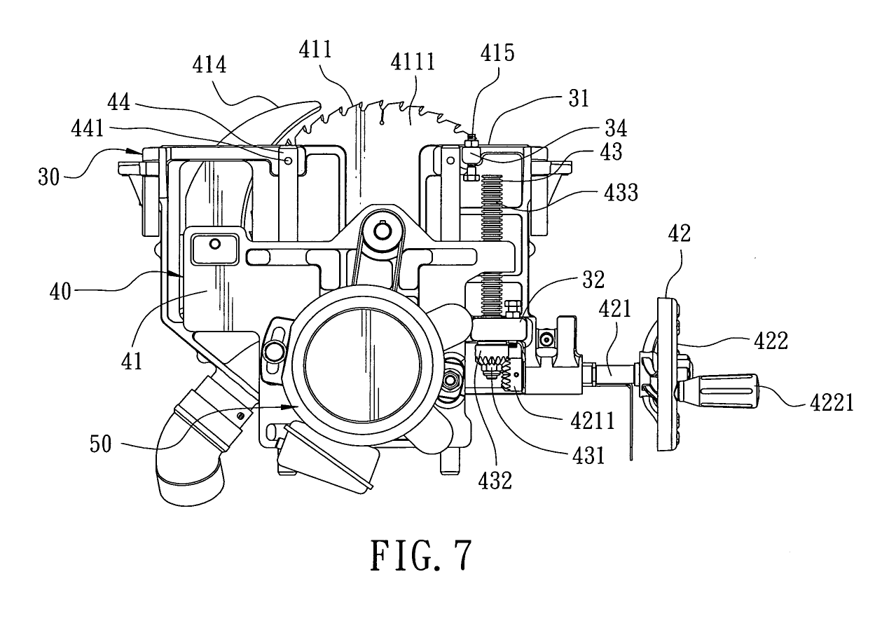

FIG. 8 is a perspective view of the saw base of the preferred embodiment of a table saw with the blade vertically elevating device in the present invention, showing the blade being adjusted to change its level.

### DETAILED DESCRIPTION OF THE PREFERRED EMBODIMENT

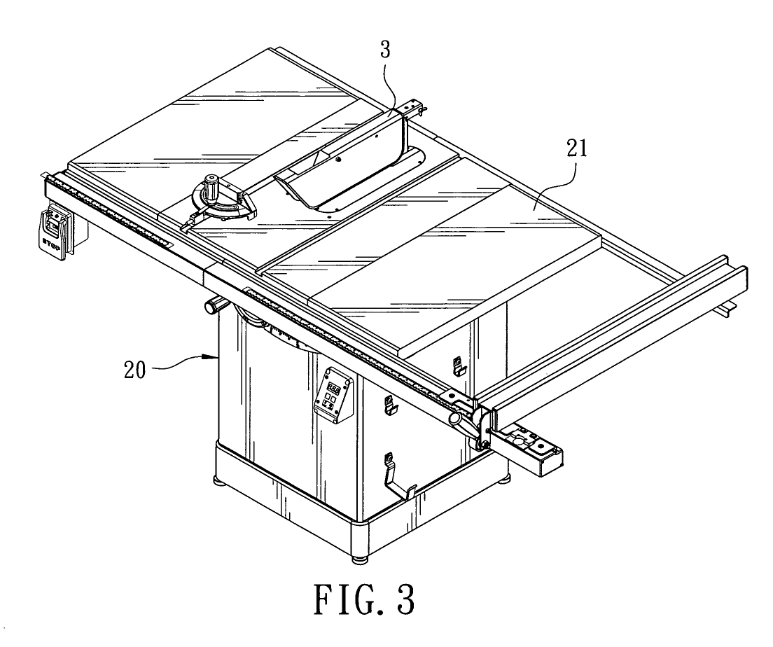

FIGS. 3˜5 show a preferred embodiment of a table saw with a blade vertically elevating device in the present invention, and the table saw includes a base 20 provided with a table 21 laid on its top, and a saw base. 3 installed above the table 21. The saw base 3 is provided with a rotating base 30, the blade vertically elevating device 40 and a motor 50.

The rotating base 30 fixed inside the base 20 is provided with an upper positioning portion 31 and a lower positioning portion 32 extended to correspond with one side of the elevating device 40, and plural positioning bars 33 located at preset positions corresponding to the blade vertically elevating device 40. The upper positioning portion 31 is bored with a through hole 311 and the lower positioning portion 32 is bored with a through hole 321. Each of the positioning bars 33 is provided with threads 331 at its front end. The rotating base 30 is also provided with a restricting portion 34 located corresponding to the upper portion of the elevating device 40, bored with a restricting hole 341, and an activating portion 35 located at its one side, bored with a pivotal hole 351 at its front side and the rear side respectively.

The elevating device 40 is composed of an elevating base 41, a main driving member 42, a threaded guiding rod 43 and two guiding rods 44.

The elevating base 41 is provided with a round blade set 411 installed at its center, a pair of guiding holes 412 bored corresponding to two sides of the rotating base 30 respectively, and a threaded guiding hole 413 bored corresponding to the through hole 311. The round blade set 411 is composed of a round blade 4111, and a shaft 4112 mounted by the round blade 4111 and screwed with a nut 4113 to keep the round blade 4111 fixed to enable it driven to rotate via the motor 50. In addition, the elevating base 41 is as well provided with a separating plate 414 installed at its top and behind the round blade set 411, and a restricting rod 415 inserted through the restricting hole 341 to be screwed with a nut 416, positioned pivotally on the top of the elevating base 41.

The main driving member 42 is provided with a rod 421 and a hand wheel 422. The hand wheel 422 is connected with one end of the rod 421 to extend outside the base 20. The rod 421 is fitted tightly in the pivotal holes 351 with the other end, provided with a bevel gear 4211 mounted on its utmost end. The hand wheel 422 is provided with a grip 4221 extended outside the base 20 for a hand to grab to turn around.

The threaded guiding rod 43 is to be inserted through the through hole 311, the threaded guiding hole 413 and the penetrating hole 321 orderly and then, screwed with a nut 431 to keep it pivotally fixed in the rotating base 30 and the elevating base 41. Additionally, the threaded guiding rod 43 is provided with a bevel gear 432 installed at its front end to engage with the bevel gear 4211 and male thread 433 formed around its surface for correspondingly screwing in the threaded guiding hole 413.

The guiding rods 44 are respectively inserted in the guiding holes 412 located at two sides of the elevating base 41, pivotally fixed in the elevating base 41. Corresponding to each positioning bar 33, a positioning hole 441 is bored in the guiding rod 44 to let the positioning bar 33 screw in to keep the guiding rod 44 fixed pivotally at one side of the rotating base 30.

The motor 50 is installed at one side of the elevating base 41, provided with a belt 51 fixed pivotally to correspond with the other side of the round blade set 411, so that the motor 50 can drive the round blade set 411 to move.

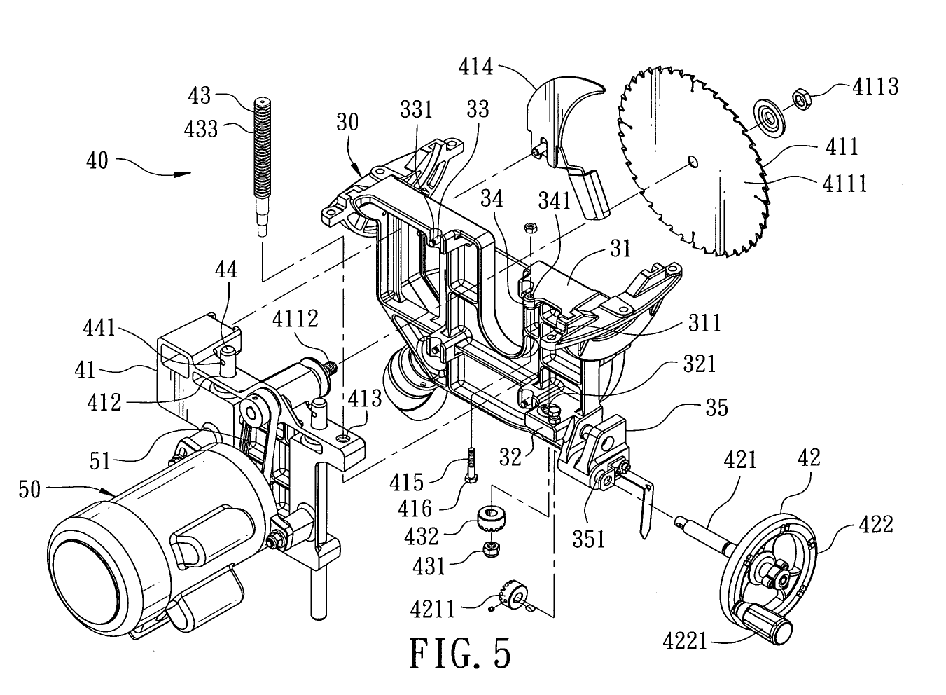

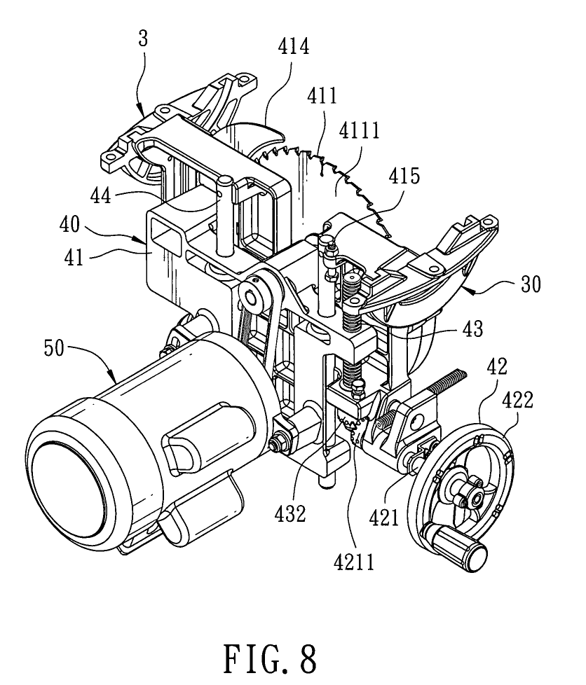

In using, as shown in FIGS. 5 and 8, when the round blade 4111 is to be lifted or descended, the handle 4221 has to be turned around to drive the rod 421 to rotate, so that the threaded guiding rod 43 can be driven by the bevel gear 4211 to whirl so as to move to and fro axially by means of its male threads 433 screwing in the threaded guiding hole 413. By t h e time, the elevating b as e 41 can be moved vertically along the guiding rods 44 and spontaneously, the round blade set 411 and the motor 50 can be moved at the same time. The restricting bar 415 is used to keep the elevating base 41 moved restrictively in a certain distance. And, the blade guard member 414 is moved spontaneously together with the round blade 4111, keeping the gap between the round blade 4111 and the separating plate 414 unchanged, so that an operator is not to touch the round blade 41111 to be injured due to such an enlarged gap possible to happen in the conventional one. It should be noted that the round blade set 411 is moved spontaneously as the elevating base 41 is vertically moved up and down, able to be swiftly changed its level through a shortest way. And, the motor 50 is fixed directly with the elevating base 41 and provided with a belt 51 mounted on the shaft 4112 to enable it maintained a certain distance from the round blade set 411, so that the motor is moved together with the elevating base, able to quickly drive the round blade set 411 to rotate.

The advantages of the invention are described below as can be seen from the foresaid description. The space between the round blade. 4111 and the separating plate 414 is always kept unchanged while altering the level of the round blade 4111, securing an operator from injured by touching the round blade 4111. And, the round blade set 411 can be quickly moved to change its level as it is installed together the elevating base 41 to move vertically in a shortest way.

While the preferred embodiment of the invention has been described above, it will be recognized and understood that various modifications may be made therein and the appended claims are intended to cover all such modifications that may fall within the spirit and scope of the invention.

What is claimed is:

1. A blade vertically elevating device for a table saw, said table saw comprising a base provided with a table laid on its top and a saw base accommodated in said table, said saw base at least comprising a rotating base, said blade vertically elevating device and a motor;
said rotating base provided with an upper positioning portion and a lower positioning portion that are both extended to correspond with one side of said blade elevating device, and plural positioning bars located at preset positions corresponding to said blade elevating device, said upper positioning portion and said lower positioning portion respectively bored with a through hole, each of said positioning bars provided with threads at its front end, said rotating base also provided with an activating portion located at its one side and bored with a pivotal hole at its front side and the rear side respectively;
said blade vertically elevating device composed of an elevating base, a main driving member, a threaded guiding rod and two guiding rods;
said elevating base provided with a round blade set installed at a certain location, a pair of guiding holes bored corresponding to two sides of said elevating base respectively, a threaded guiding hole bored corresponding to said through hole of said upper positioning portion and a separating plate installed at its top and behind said round blade set;
said main driving member provided with a rod and a hand wheel, said hand wheel connected with one end of said rod, said rod pivotally fitted in said pivotal holes with the other end and provided with a bevel gear mounted on its utmost end;
said threaded guiding rod inserted through said through hole, said threaded guiding hole and said through hole orderly and then, screwed with a nut to keep it pivotally fixed in said rotating base and said elevating base; said threaded guiding rod in addition provided with a bevel gear installed at its front end to engage with said bevel gear of said rod and male threads formed around its surface for correspondingly screwing in said threaded guiding hole;
said two guiding rods respectively inserted in the guiding holes located at two sides of said elevating base, pivotally fixed in the elevating base, each of said guiding rod provided with a positioning hole bored to correspondingly be screwed by said positioning bar so as to keep said guiding rod fixed pivotally at one side of said rotating base;
said motor installed fixedly at one side of said elevating base; and
said threaded guiding rod able to be driven by said main driving member to move axially in said threaded guiding hole of said elevating base, so as to spontaneously keep said motor, said separating plate and said round blade moved vertically along said guiding rods.

2. The blade vertically elevating device for a table saw as claimed in claim 1, wherein said rotating base is provided with a restricting portion located corresponding to one side of said elevating base and bored with a restricting hole for a restricting bar to pass through to be screwed with a nut to get fixed on said elevating base.

3. The blade vertically elevating device for a table saw as claimed in claim 1, wherein said motor is provided with a belt fixed pivotally beside said elevating base to correspond with said round blade member and said elevating base is provided with a shaft to connect with said round blade set screwed fixedly by a nut, so that said motor can drive said round blade set to rotate.

4. The blade vertically elevating device for a table saw as claimed in claim 1, wherein said hand wheel of said main driving member is provided with a grip for a user to grab easily to turn around.
